(19) United States
(12) Patent Application Publication
(10) Pub. No.: US 2022/0036097 A1
(43) Pub. Date: Feb. 3, 2022

(54) ROAD SURFACE DETECTION DEVICE AND ROAD SURFACE DETECTION PROGRAM

(71) Applicant: AISIN CORPORATION, Kariya-shi, Aichi (JP)

(72) Inventors: Atsuto OGINO, Kariya-shi, Aichi-ken (JP); Kaisei HASHIMOTO, Kariya-shi, Aichi-ken (JP)

(73) Assignee: AISIN CORPORATION, Kariya-shi, Aichi (JP)

(21) Appl. No.: 17/299,625

(22) PCT Filed: Nov. 29, 2019
(86) PCT No.: PCT/JP2019/046857

§ 371 Date: Jun. 3, 2021

(30) Foreign Application Priority Data
Dec. 4, 2018 (JP) 2018-227342

(51) Int. Cl. G06K 9/00; H04N 13/111; H04N 5/232; H04N 13/221

(52) U.S. Cl. CPC G06K 9/00798; H04N 13/111; H04N 13/221; H04N 5/23267; G06K 9/00214

(57) ABSTRACT

A road surface detection device according to an embodiment includes an image acquisition unit that acquires captured image data output from a stereo camera that captures an imaging area including a road surface on which a vehicle travels, a three-dimensional model generation unit that generates a three-dimensional model of the imaging area including a surface shape of the road surface from a viewpoint of the stereo camera based on the captured image data, and a correction unit that estimates a plane from the three-dimensional model, and corrects the three-dimensional model so as to match an orientation of a normal vector of the plane and a height position of the plane with respect to the stereo camera with a correct value of an orientation of a normal vector of the road surface and a correct value of a height position of the road surface with respect to the stereo camera, respectively.

### CROSS-REFERENCE TO RELATED APPLICATIONS

This application is a national stage application of International Application No. PCT/JP2019/046857, filed Nov. 29, 2019, which designates the United States, incorporated herein by reference, and which claims the benefit of priority from Japanese Patent Application No. 2018-227342, filed Dec. 4, 2018, the entire contents of which are incorporated herein by reference.

### TECHNICAL FIELD

Embodiments of the present disclosure relate to a road surface detection device and a road surface detection computer program product.

### BACKGROUND ART

Conventionally, a technique has been known for detecting a state of a road surface such as a height position of the road surface with respect to an imaging unit based on captured image data output from the imaging unit such as a stereo camera that captures an imaging area including a road surface on which a vehicle travels.

### CITATION LIST

### Patent Literature

Patent Document 1: Japanese Patent No. 6209648

### SUMMARY OF DISCLOSURE

### Problem to be Solved by Various Aspects of the Disclosure

In the conventional technique as described above, shaking of the imaging unit due to shaking of the vehicle is not taken into consideration. When the imaging unit shakes, a road surface that is actually flat is detected as a road surface having unevenness on the captured image data, and thus the detection accuracy of the road surface may deteriorate.

### Means for Solving Problem

A road surface detection device according to the embodiment of the present disclosure includes an image acquisition unit that acquires captured image data output from a stereo camera that captures an imaging area including a road surface on which a vehicle travels, a three-dimensional model generation unit that generates a three-dimensional model of the imaging area including a surface shape of the road surface from a viewpoint of the stereo camera based on the captured image data, and a correction unit that estimates a plane from the three-dimensional model, and corrects the three-dimensional model so as to match an orientation of a normal vector of the plane and a height position of the plane with respect to the stereo camera with a correct value of an orientation of a normal vector of the road surface and a correct value of a height position of the road surface with respect to the stereo camera, respectively.

Therefore, as an example, deterioration of the detection accuracy of the road surface can be suppressed.

The correction unit further matches the orientation of the normal vector of the plane with the correct value of the orientation of the normal vector of the road surface, and then corrects the entire three-dimensional model so as to match the height position of the plane with respect to the stereo camera with the correct value of the height position of the road surface with respect to the stereo camera.

Therefore, as an example, the correction can be easily executed.

The correction unit further acquires the correct value of the orientation of the normal vector of the road surface and the correct value of the height position of the road surface with respect to the stereo camera based on values determined during calibration of the stereo camera.

Therefore, as an example, the correct values can be easily obtained.

A road surface detection program according to the embodiment of the present disclosure causes a computer to execute an image acquisition step of acquiring captured image data output from a stereo camera that captures an imaging area including a road surface on which a vehicle travels, a three-dimensional model generation step of generating a three-dimensional model of the imaging area including a surface shape of the road surface from a viewpoint of the stereo camera based on the captured image data, and a correction step of estimating a plane from the three-dimensional model, and correcting the three-dimensional model so as to match an orientation of a normal vector of the plane and a height position of the plane with respect to the stereo camera with a correct value of an orientation of a normal vector of the road surface and a correct value of a height position of the road surface with respect to the stereo camera, respectively.

Therefore, as an example, deterioration of the detection accuracy of the road surface can be suppressed.

### BRIEF DESCRIPTION OF DRAWINGS

FIG. 1 is a perspective view illustrating an example of a state in which a part of a vehicle compartment of a vehicle equipped with a road surface detection device according to an embodiment is seen through;

FIG. 2 is a plan view illustrating an example of the vehicle equipped with the road surface detection device according to the embodiment;

FIG. 3 is a block diagram illustrating an example of a configuration of an electronic control unit (ECU) and a peripheral configuration of the ECU according to the embodiment;

FIG. 4 is a diagram illustrating a software configuration realized by the ECU according to the embodiment;

FIGS. 5A to 5D are diagrams illustrating an outline of a road surface detection function of the ECU according to the embodiment;

FIGS. 6A and 6B are diagrams illustrating details of the road surface detection function of the ECU according to the embodiment;

FIGS. 7A and 7B are diagrams illustrating details of the road surface detection function of the ECU according to the embodiment;

FIGS. 8A and 8B are diagrams illustrating details of the road surface detection function of the ECU according to the embodiment;

FIG. 9 is a flow chart illustrating an example of procedures of road surface detection processing by the ECU according to the embodiment; and

FIG. 10 illustrates a detection result of a flat road surface by the ECU according to the embodiment and a configuration according to a comparative example.

### DESCRIPTION OF EMBODIMENTS

Hereinafter, exemplary embodiments of the present disclosure will be disclosed. Configurations of the embodiments indicated below, as well as actions, results, and effects produced by the configurations, are examples. The present disclosure can be realized by a configuration other than the configurations disclosed in the following embodiments, and at least one of various effects based on the basic configuration and derivative effects can be obtained.

### Embodiment

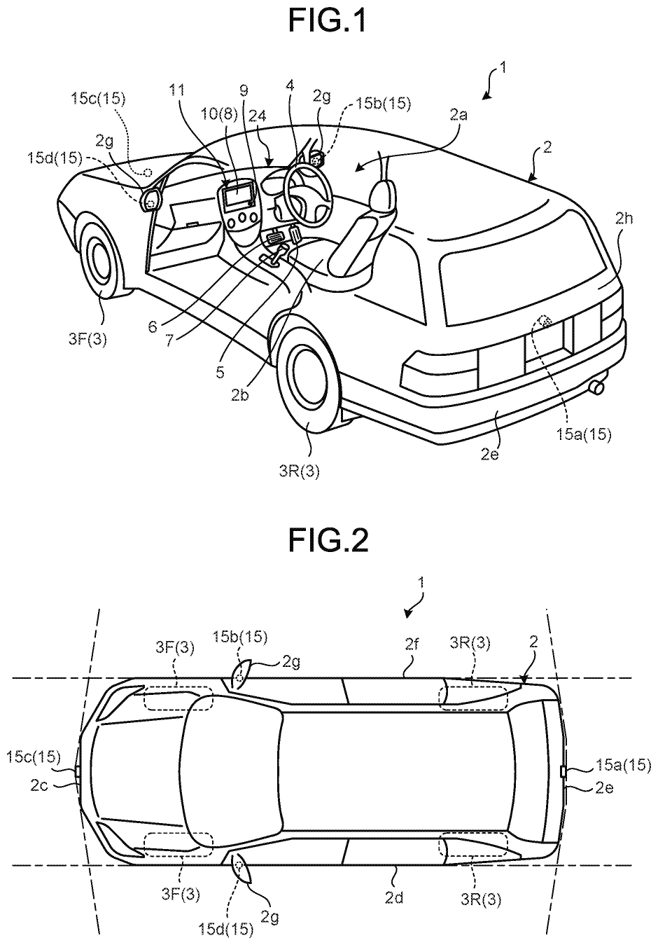

The configurations of the embodiments will be described with reference to FIGS. 1 to 10.

(Vehicle Configuration)

FIG. 1 is a perspective view illustrating an example of a state in which a part of a vehicle compartment 2a of a vehicle 1 equipped with a road surface detection device according to an embodiment is seen through. FIG. 2 is a plan view illustrating an example of the vehicle 1 equipped with the road surface detection device according to the embodiment.

The vehicle 1 of the embodiment may be, for example, a vehicle having an internal combustion engine (not illustrated) as a drive source, that is, an internal combustion engine vehicle, or a vehicle having an electric motor (not illustrated) as a drive source, that is, an electric vehicle, a fuel cell vehicle, or the like, or a hybrid vehicle using both of an internal combustion engine and an electric motor as drive sources, or a vehicle having another drive source. Further, the vehicle 1 can be equipped with various transmissions, and can be equipped with various devices necessary for driving an internal combustion engine or an electric motor, such as a system or a component. In addition, a method, number, layout, and the like of devices involved in driving wheels 3 in the vehicle 1 can be set in various ways.

As illustrated in FIG. 1, a vehicle body 2 constitutes the vehicle compartment 2a on which an occupant (not illustrated) rides. In the vehicle compartment 2a, a steering unit 4, an acceleration operation unit 5, a braking operation unit 6, a speed change operation unit 7, and the like are provided while facing a seat 2b for a driver as an occupant. The steering unit 4 is, for example, a steering wheel protruding from a dashboard 24. The acceleration operation unit 5 is, for example, an accelerator pedal located under the driver's feet. The braking operation unit 6 is, for example, a brake pedal located under the driver's feet. The speed change operation unit 7 is, for example, a shift lever protruding from a center console. The steering unit 4, the acceleration operation unit 5, the braking operation unit 6, the speed change operation unit 7, and the like are not limited thereto.

Further, a display device 8 and an audio output device 9 are provided in the vehicle compartment 2a. The audio output device 9 is, for example, a speaker. The display device 8 is, for example, an LCD (Liquid Crystal Display), an OELD (Organic Electroluminescent Display), or the like. The display device 8 is covered with a transparent operation input unit 10 such as a touch panel. The occupant can visually recognize an image displayed on a display screen of the display device 8 via the operation input unit 10. In addition, the occupant can execute operation input by touching, pushing, or moving the operation input unit 10 with his or her fingers or the like at a position corresponding to the image displayed on the display screen of the display device 8. The display device 8, the audio output device 9, the operation input unit 10, and the like are provided, for example, in a monitor device 11 located at a center of the dashboard 24 in a vehicle width direction, that is, in a left-right direction. The monitor device 11 can have operation input units (not illustrated) such as switches, dials, joysticks, and push buttons. Further, an audio output device (not illustrated) can be provided at another position in the vehicle compartment 2a different from the monitor device 11. Furthermore, audio can be output from the audio output device 9 of the monitor device 11 and other audio output devices. The monitor device 11 can also be used as, for example, a navigation system or an audio system.

As illustrated in FIGS. 1 and 2, the vehicle 1 is, for example, a four-wheeled vehicle, and has two left and right front wheels 3F and two left and right rear wheels 3R. All of these four wheels 3 can be configured to be steerable.

Further, the vehicle body 2 is provided with, for example, four imaging units 15a to 15d as a plurality of imaging units 15. The imaging units 15 are, for example, digital stereo cameras each incorporating an image pickup element such as a CCD (Charge Coupled Device) or a CIS (CMOS Image Sensor). A stereo camera simultaneously captures an object with a plurality of cameras, and detects a position and a three-dimensional shape of the object from a difference in the position of the object obtained by each camera on the image, that is, parallax. As a result, shape information of a road surface and the like included in the image can be acquired as three-dimensional information.

The imaging units 15 can output captured image data at a predetermined frame rate. The captured image data may be moving image data. Each of the imaging units 15 has a wide-angle lens or a fisheye lens, and can photograph a range of, for example, 140° or more and 220° or less in a horizontal direction. Further, an optical axis of the imaging unit 15 may be set obliquely downward. As a result, the imaging unit 15 sequentially photographs a surrounding environment outside the vehicle 1 including a road surface and an object on which the vehicle 1 can move, and outputs the captured image data. Here, the object is a rock, a tree, a human being, a bicycle, another vehicle, or the like, which can be an obstacle when the vehicle 1 is traveling.

The imaging unit 15a is located, for example, at a rear end 2e of the vehicle body 2 and is provided on a lower wall of a rear window of a rear hatch door 2h. The imaging unit 15b is located, for example, at a right end 2f of the vehicle body 2 and is provided on a right door mirror 2g. The imaging unit 15c is located, for example, on a front side of the vehicle body 2, that is, on a front end 2c in a front-rear direction of the vehicle, and is provided on a front bumper, a front grill, or the like. The imaging unit 15d is located, for example, at a left end 2d of the vehicle body 2 and is provided on a left door mirror 2g.

(ECU Hardware Configuration)

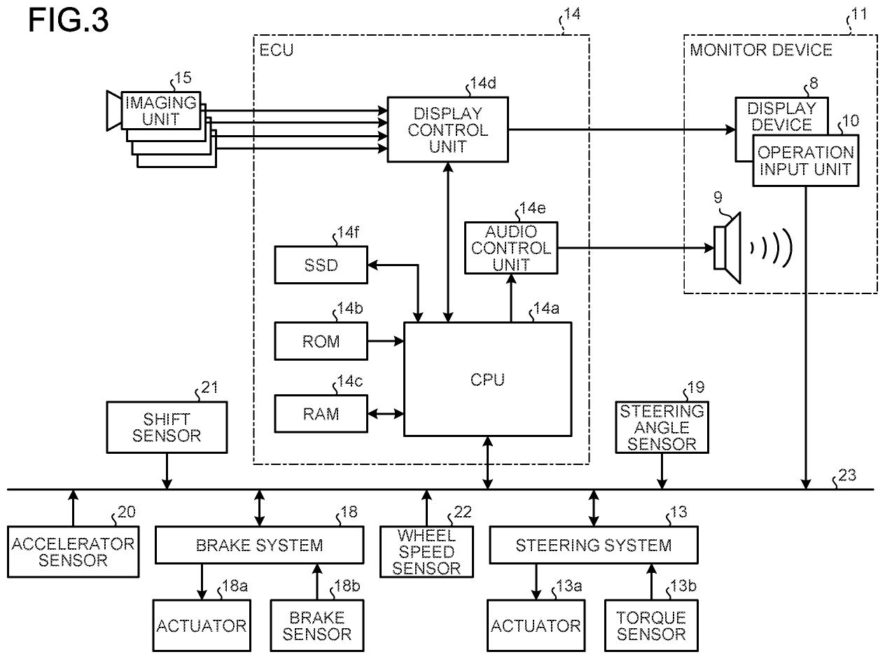

Next, an ECU (Electronic Control Unit) 14 of the embodiment and a peripheral configuration of the ECU 14 will be described with reference to FIG. 3. FIG. 3 is a block diagram illustrating the configuration of the ECU 14 and a peripheral configuration of the ECU 14 according to the embodiment.

As illustrated in FIG. 3, in addition to the ECU 14 as a road surface detection device, the monitor device 11, a steering system 13, a brake system 18, a steering angle sensor 19, an accelerator sensor 20, a shift sensor 21, a wheel speed sensor 22, and the like are electrically connected via an in-vehicle network 23 as an electric telecommunication line. The in-vehicle network 23 is configured as, for example, a CAN (Controller Area Network).

The ECU 14 can control the steering system 13, the brake system 18, and the like by sending a control signal through the in-vehicle network 23. In addition, the ECU 14 can receive detection results of a torque sensor 13b, a brake sensor 18b, the steering angle sensor 19, the accelerator sensor 20, the shift sensor 21, the wheel speed sensor 22, and the like, and operation signals of the operation input unit 10 and the like via the in-vehicle network 23.

In addition, the ECU 14 executes arithmetic processing and image processing based on image data obtained by the plurality of imaging units 15 to generate an image with a wider viewing angle, and generates a virtual overhead view image of the vehicle 1 viewed from above.

The ECU 14 has, for example, a CPU (Central Processing Unit) 14a, a ROM (Read Only Memory) 14b, a RAM (Random Access Memory) 14c, a display control unit 14d, an audio control unit 14e, an SSD (Solid State Drive) 14f that is a flash memory, and the like.

The CPU 14a can execute various arithmetic processing and control such as image processing related to an image displayed on the display device 8, determining of a target position of the vehicle 1, calculation of a movement path of the vehicle 1, determining of whether or not there is an interference with an object, automatic control of the vehicle 1, and cancellation of automatic control. The CPU 14a can read a program installed and stored in a non-volatile storage device such as the ROM 14b, and execute arithmetic processing according to the program. Such a program includes a road surface detection program which is a computer program for realizing road surface detection processing in the ECU 14.

The RAM 14c temporarily stores various data used in calculation by the CPU 14a.

The display control unit 14d mainly executes image processing using image data obtained by the imaging unit 15 and synthesizing image data displayed by the display device 8 among the arithmetic processing in the ECU 14.

The audio control unit 14e mainly executes processing of audio data output by the audio output device 9 among the arithmetic processing in the ECU 14.

The SSD 14f is a rewritable non-volatile storage unit that can store data even when the power of the ECU 14 is turned off.

The CPU 14a, the ROM 14b, the RAM 14c, and the like can be integrated in the same package. Further, the ECU 14 may have a configuration in which another logical arithmetic processor such as a DSP (Digital Signal Processor), a logic circuit, or the like is used instead of the CPU 14a. Further, an HDD (Hard Disk Drive) may be provided instead of the SSD 14f, and the SSD 14f and the HDD may be provided separately from the ECU 14.

The steering system 13 has an actuator 13a and the torque sensor 13b to steer at least two of the wheels 3. That is, the steering system 13 is electrically controlled by the ECU 14 or the like to operate the actuator 13a. The steering system 13 is, for example, an electric power steering system, an SBW (Steer by Wire) system, or the like. The steering system 13 adds torque, that is, assist torque, to the steering unit 4 by the actuator 13a to supplement steering force, or steers the wheels 3 by the actuator 13a. In this case, the actuator 13a may steer one of the wheels 3 or a plurality of the wheels 3. Further, the torque sensor 13b detects, for example, torque given to the steering unit 4 by the driver.

The brake system 18 is, for example, an ABS (Anti-lock Brake System) that suppresses brake lock, a sideslip prevention device (ESC: Electronic Stability Control) that suppresses sideslip of vehicle 1 during cornering, an electric brake system that increases braking force to execute brake assist, BBW (Brake by Wire), or the like. The brake system 18 applies braking force to the wheels 3 and thus to the vehicle 1 via an actuator 18a. In addition, the brake system 18 can detect signs of brake lock, idling of the wheels 3, sideslip, and the like from a difference in rotation between the left and right wheels 3 and execute various controls. The brake sensor 18b is, for example, a sensor that detects a position of a movable portion of the braking operation unit 6. The brake sensor 18b can detect a position of a brake pedal as a movable portion. The brake sensor 18b includes a displacement sensor.

The steering angle sensor 19 is, for example, a sensor that detects a steering amount of the steering unit 4 such as a steering wheel. The steering angle sensor 19 is configured by using, for example, a Hall element or the like. The ECU 14 acquires the steering amount of the steering unit 4 by the driver, the steering amount of each of the wheels 3 during automatic steering, and the like from the steering angle sensor 19 and executes various controls. The steering angle sensor 19 detects a rotation angle of a rotating portion included in the steering unit 4. The steering angle sensor 19 is an example of an angle sensor.

The accelerator sensor 20 is, for example, a sensor that detects a position of a movable portion of the acceleration operation unit 5. The accelerator sensor 20 can detect a position of an accelerator pedal as a movable portion. The accelerator sensor 20 includes a displacement sensor.

The shift sensor 21 is, for example, a sensor that detects a position of a movable portion of the speed change operation unit 7. The shift sensor 21 can detect positions of levers, arms, buttons, and the like as movable portions. The shift sensor 21 may include a displacement sensor or may be configured as a switch.

The wheel speed sensor 22 is a sensor that detects a rotation amount of the wheels 3 and the number of rotations per unit time. The wheel speed sensor 22 outputs the number of wheel speed pulses indicating the detected number of rotations as a sensor value. The wheel speed sensor 22 may be configured by using, for example, a Hall element or the like. The ECU 14 calculates a movement amount of the vehicle 1 based on the sensor value acquired from the wheel speed sensor 22, and executes various controls. The wheel speed sensor 22 may be provided in the brake system 18. In that case, the ECU 14 acquires a detection result of the wheel speed sensor 22 via the brake system 18.

The configurations, arrangements, electrical connection forms, and the like of the various sensors and actuators described above are examples, and can be set and changed in various ways.

(ECU Software Configuration)

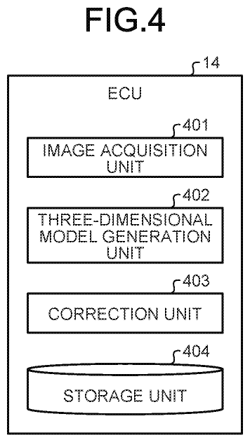

Next, a software configuration indicating functions of the ECU 14 of the embodiment will be described with reference to FIG. 4. FIG. 4 is a diagram illustrating a software configuration realized by the ECU 14 according to the embodiment. The functions illustrated in FIG. 4 are realized through collaboration of software and hardware. That is, in the example illustrated in FIG. 4, functions of the ECU 14 as a road surface detection device are realized as a result of the CPU 14a reading and executing the road surface detection program stored in the ROM 14b or the like.

As illustrated in FIG. 4, the ECU 14 as a road surface detection device includes an image acquisition unit 401, a three-dimensional model generation unit 402, a correction unit 403, and a storage unit 404. The CPU 14a described above functions as the image acquisition unit 401, the three-dimensional model generation unit 402, the correction unit 403, and the like by executing processing according to a program. The RAM 14c, the ROM 14b, and the like function as the storage unit 404. In addition, at least a part of the functions of the above-mentioned units may be realized by hardware.

The image acquisition unit 401 acquires a plurality of pieces of captured image data from the plurality of imaging units 15 that captures a peripheral area of the vehicle 1. The imaging area of the imaging units 15 includes a road surface on which the vehicle 1 travels, and the captured image data includes a surface shape of the road surface and the like.

The three-dimensional model generation unit 402 generates a three-dimensional model from the captured image data acquired by the image acquisition unit 401. The three-dimensional model is a three-dimensional point group in which a plurality of points are arranged three-dimensionally according to a state of the road surface such as the surface shape of a road surface including the road surface on which the vehicle 1 travels.

The correction unit 403 corrects an inclination of the three-dimensional model generated by the three-dimensional model generation unit 402. The three-dimensional model is generated based on a state of the vehicle 1 such as an orientation of the vehicle body 2. Therefore, even when the vehicle 1 is inclined, the correction unit 403 makes a correction so that the state of the road surface and the like is correctly reflected.

The storage unit 404 stores data used in arithmetic processing of each unit, data as a result of the arithmetic processing, and the like. Further, the storage unit 404 stores data of calibration performed on the imaging units 15 and the like when the vehicle 1 is shipped from a factory.

(ECU Function Example)

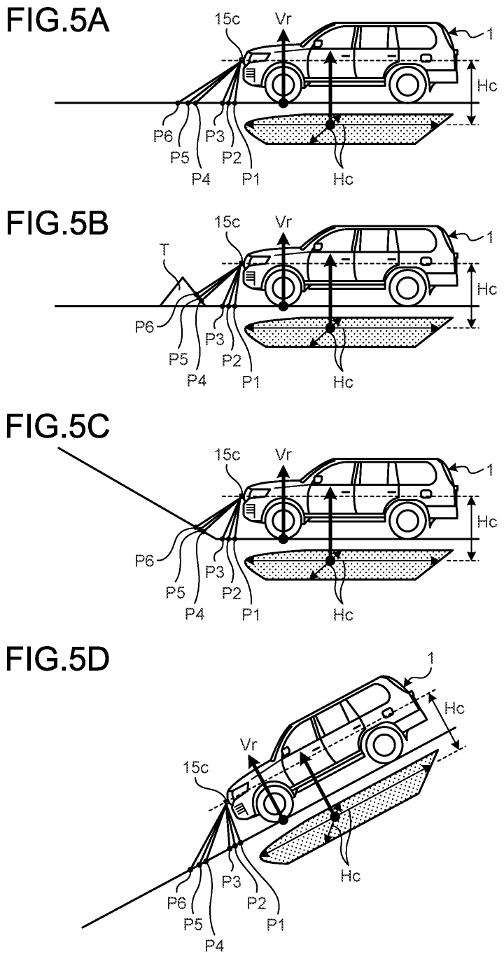

Next, a function example of the ECU 14 of the embodiment will be described with reference to FIGS. 5A and 5B. FIGS. 5A-5D are diagrams illustrating an outline of the road surface detection function of the ECU 14 according to the embodiment.

As a premise, when the vehicle 1 is shipped from the factory, calibration is performed on the imaging units 15 so that a captured image can be obtained correctly. The calibration includes, for example, optical axis correction. By this calibration, a normal vector perpendicular to the road surface and a height position of the road surface are determined based on a viewpoint of each of the imaging units 15. In the road surface detection by the ECU 14, the normal vector of the road surface and the height position of the road surface based on the viewpoint of the imaging unit 15 are used as correct values. Based on such correct values, distance to a predetermined point on the road surface and the like and a height of the predetermined point can be appropriately calculated from the captured image data by the imaging unit 15.

That is, for example, as illustrated in FIG. 5A, the state of the road surface is detected mainly based on captured image data captured by the imaging unit 15c in a front portion of the vehicle 1. For example, among the captured image data captured by the imaging unit 15c, the state of the road surface based on the distance to and heights of predetermined points P1 to P3 on the road surface closest to the vehicle 1 is regarded as the state of the road surface on which the vehicle 1 is located at this time, that is, the road surface directly under the vehicle 1. Here, a flat road surface parallel to the vehicle 1 is detected.

Further, among the captured image data captured by the imaging unit 15c, the state of the road surface slightly ahead of the vehicle 1 is detected based on the distance to and heights of predetermined points P4 to P6 on the road surface slightly away from the vehicle 1. Here, a flat road surface parallel to the road surface on which the vehicle 1 is located is detected.

Further, for example, as illustrated in FIG. 5B, an object T having a predetermined height is detected slightly ahead of the flat road surface on which the vehicle 1 is located, based on the distance to and heights of the predetermined points P4 to P6 on the road surface.

Further, for example, as illustrated in FIG. 5C, a ramp such as an uphill is detected slightly ahead of the flat road surface on which the vehicle 1 is located, based on the distance to and heights of the predetermined points P4 to P6 on the road surface.

Further, for example, as illustrated in FIG. 5D, when the vehicle 1 is located on a ramp such as a downhill, a flat road surface parallel to the vehicle 1 is detected based on the distance to and height from the predetermined points P1 to P3 on the road surface. Further, a flat road surface parallel to the road surface on which the vehicle 1 is located is detected, based on the distance to and height of the predetermined points P4 to P6 of the road surface. That is, the state of the road surface is detected assuming that the road surface at the current position of the vehicle 1 is parallel to the vehicle 1 regardless of the inclination of the road surface with respect to the direction of gravity.

As described above, the ECU 14 of the embodiment uses an orientation of a normal vector Vc of the road surface determined by calibration as a correct value, that is, a direction in which a normal vector Vr of the road surface should be oriented. That is, it is presumed that the orientation of the normal vector Vr perpendicular to the detected road surface matches the orientation of the normal vector Vc, which is the correct value. In addition, a height position Hc of the road surface determined by calibration is used as a correct value, that is, a height that the road surface should have, and an object having a height that does not match the height position Hc is detected. As in the above example, an object having a height that does not match the height position Hc is, for example, an object such as a pebble falling on the road surface or unevenness of the road surface. As in the example of FIG. 5C, there may be another road surface having an inclination different from the road surface on which the vehicle 1 is located.

Road surface information used for detecting the state of the road surface is not limited to the above-mentioned predetermined points P1 to P6. For example, the ECU 14 acquires road surface information over an entire range that can be captured by the imaging unit 15c, and identifies the state of the road surface.

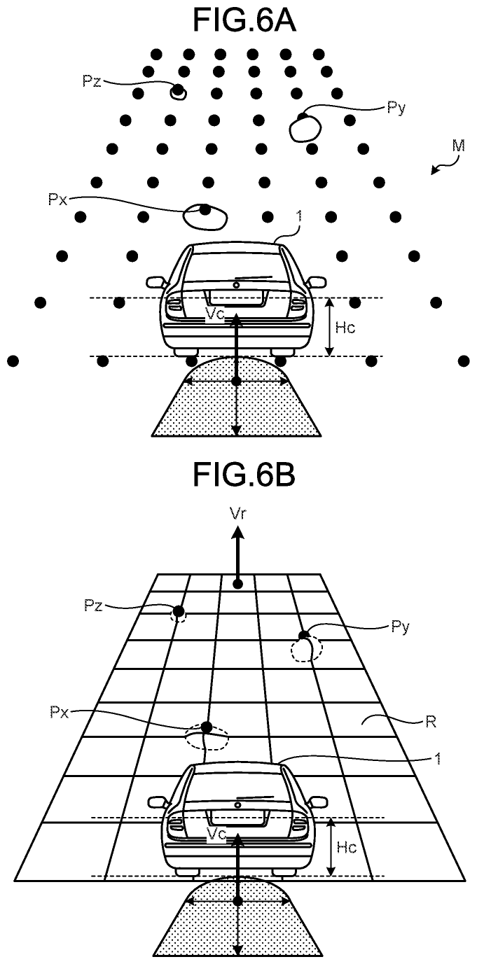

Next, further details of the functions of the ECU 14 of the embodiment will be described with reference to FIGS. 6A to 8B. FIGS. 6A to 8B are diagrams for explaining the details of the road surface detection function of the ECU 14 according to the embodiment. The following processing by the ECU 14 is mainly performed based on captured image data captured by the imaging unit 15c in the front portion of the vehicle 1. As described above, the captured image data is acquired by the image acquisition unit 401 of the ECU 14.

First, a state when the vehicle 1 keeps a posture parallel to the road surface will be described.

As shown in FIG. 6A, the three-dimensional model generation unit 402 generates a three-dimensional model M based on the captured image data acquired by the image acquisition unit 401. In the three-dimensional model M, various objects such as the road surface, unevenness of the road surface, and objects on the road surface are converted into a plurality of points arranged three-dimensionally according to distance from the vehicle 1 to the various objects and heights of the various objects.

The correction unit 403 estimates the position and orientation of the road surface from the three-dimensional model M generated by the three-dimensional model generation unit 402. The position and orientation of the road surface are estimated on the assumption that the road surface is a plane having ideal flatness that does not include unevenness, other objects or the like. Such a plane can be determined using, for example, robust estimation such as random sample consensus (RANSAC). In robust estimation, when obtained observation values include outliers, the outliers are excluded and the law of the observation object is estimated. That is, here, points Px, Py, and Pz indicating unevenness and other objects included in the three-dimensional model M are excluded, and the flatness of each position and each orientation in the three-dimensional model M is estimated so as to obtain a plane oriented in a predetermined direction at a predetermined position.

As illustrated in FIG. 6B, the correction unit 403 calculates the normal vector Vr perpendicular to a plane R estimated as described above. Further, the correction unit 403 matches the orientation of the normal vector Vr of the plane R with the orientation of the normal vector Vc as a correct value determined by calibration, and then corrects a height position of the entire three-dimensional point group included in the three-dimensional model M based on the height position Hc as a correct value determined by calibration. In the corrected three-dimensional model M, the points Px, Py, and Pz excluded as outliers do not match the height position Hc and are indicated as unevenness having a predetermined height on the road surface.

In FIG. 6B, the orientation of the normal vector Vr on the plane R matches the orientation of the normal vector Vc as the correct value, and such correction by the correction unit 403 seems to be unnecessary. However, the example in FIGS. 6A-6B are just an ideal example. The vehicle 1 may be constantly shaken due to influence of the unevenness of the road surface, and the inclination of the normal vector Vr of the plane R with respect to the normal vector Vc can always change.

Therefore, a state when the vehicle 1 is shaken will be described.

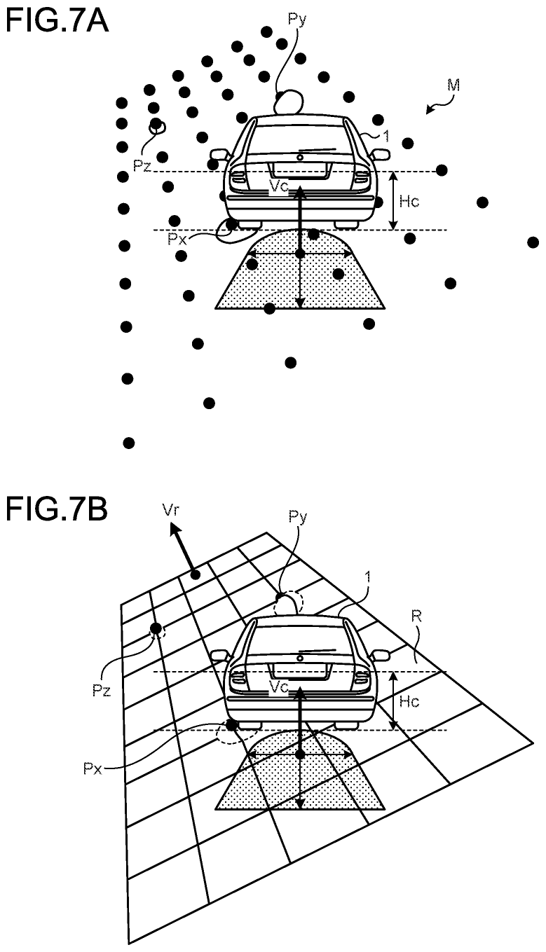

FIGS. 7A-7B illustrate the vehicle 1 riding on an object on a road. At this time, the vehicle 1 is actually inclined, but on the captured image data captured by the imaging unit 15, the road surface on the right side of the vehicle 1 is raised and the road surface on the left side is depressed.

As illustrated in FIG. 7A, the three-dimensional model generation unit 402 generates the three-dimensional model M based on the captured image data acquired by the image acquisition unit 401.

As illustrated in FIG. 7B, the correction unit 403 estimates the position and orientation of the plane R from the three-dimensional model M generated by the three-dimensional model generation unit 402. Then, the correction unit 403 calculates the normal vector Vr of the estimated plane R. In the example illustrated in FIG. 7B, the normal vector Vr of the plane R does not match the normal vector Vc as the correct value.

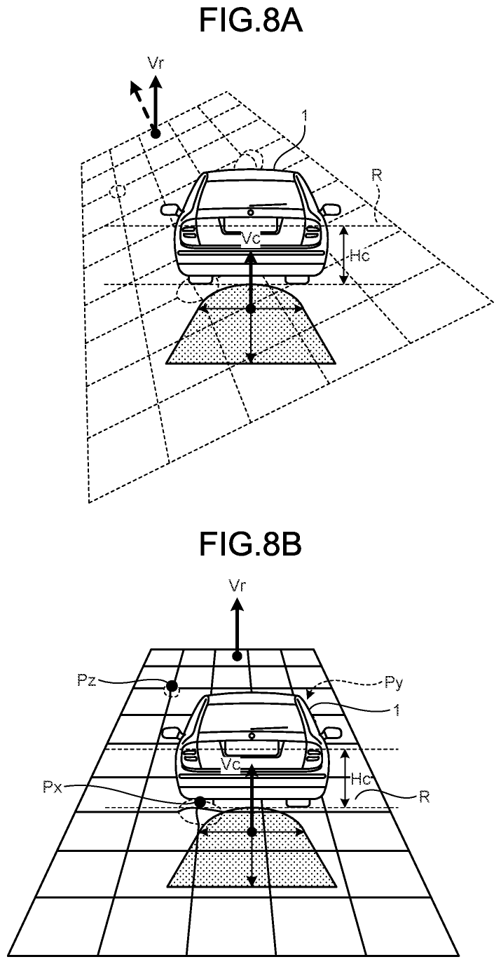

As illustrated in FIG. 8A, the correction unit 403 corrects the inclination of the normal vector Vr of the plane R so that the normal vector Vr of the plane R matches the normal vector Vc as the correct value. In other words, the correction unit 403 offsets the normal vector Vr of the plane R in a direction in which the plane R is parallel to the front-rear and left-right axes of the vehicle 1.

As illustrated in FIG. 8B, the correction unit 403 adjusts the height position of the plane R to the height position Hc as the correct value. At this time, the height position of the entire three-dimensional point group included in the three-dimensional model M is corrected. In other words, the height position of the entire three-dimensional point group is corrected to the height position with the imaging unit 15c as the viewpoint.

As a result, points included in the plane R of the three-dimensional point group overlap with a virtual road surface parallel to the vehicle 1 at the height position Hc. Further, the points Px, Py, and Pz indicating unevenness of the road surface and other objects of the three-dimensional point group do not overlap with the virtual road surface and are indicated as unevenness having a predetermined height.

(Example of Road Surface Detection Processing by ECU)

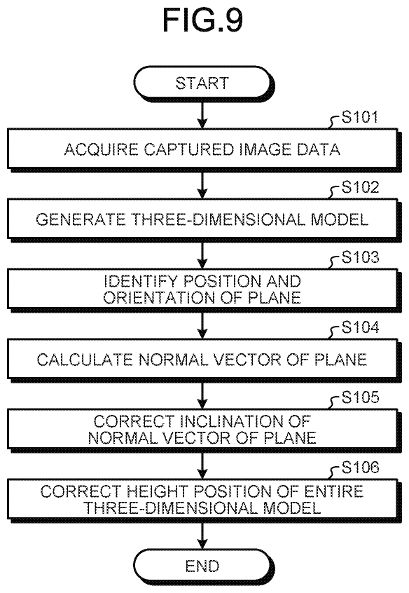

Next, an example of the road surface detection processing by the ECU 14 of the embodiment will be described with reference to FIG. 9. FIG. 9 is a flow chart illustrating an example of procedures of the road surface detection processing by the ECU 14 according to the embodiment.

As illustrated in FIG. 9, the image acquisition unit 401 of the ECU 14 acquires the captured image data captured by the imaging unit 15 (step S101). In detection of the state of the road surface described below, the captured image data captured by the imaging unit 15c installed in the front portion of the vehicle 1 is mainly used. The captured image data is preferably moving image data.

The three-dimensional model generation unit 402 mainly generates a three-dimensional model M in which a plurality of points are arranged three-dimensionally from the captured image data captured by the imaging unit 15c (step S102). The three-dimensional model M includes unevenness of the road surface and an uneven state of the road surface including objects on the road surface.

The correction unit 403 identifies the position and orientation of the plane R from the generated three-dimensional model M (step S103). That is, the correction unit 403 estimates the plane R having a predetermined position and orientation from the three-dimensional model M by calculation such as robust estimation. The estimated plane R does not include data indicating the uneven state.

The correction unit 403 calculates the normal vector Vr for the identified plane R (step S104).

The correction unit 403 corrects an inclination of the normal vector Vr of the plane R (step S105). Specifically, the correction unit 403 inclines the normal vector Vr of the plane R by a predetermined angle as necessary, and makes a correction so that the orientation of the normal vector Vr of the plane R is perpendicular to the normal vector Vc as the correct value.

The correction unit 403 corrects the height position of the entire three-dimensional model M (step S106). That is, the correction unit 403 corrects the height position of the entire three-dimensional model M based on the height position Hc as the correct value. The height position of the entire three-dimensional model M is corrected by moving all the positions of the three-dimensional point group included in the three-dimensional model M for distance relative to movement distance of the three-dimensional point group included in the plane R.

By the processing of steps S103 to S106 by the correction unit 403, the three-dimensional model is corrected so that the plane R is horizontal with respect to the vehicle 1 based on the normal vectors. As a result, points estimated to indicate the plane R from the three-dimensional point group overlap with the height position Hc of the virtual road surface, and other points are determined as unevenness of the road surface having a predetermined height. The unevenness having a predetermined height on the road surface may be unevenness of the road surface, an object on the road surface, another road surface such as a ramp having an inclination different from the road surface on which the vehicle 1 is located.

As described above, the road surface detection processing by the ECU 14 of the embodiment is completed.

### Comparative Example

For example, as a comparative example, a configuration is assumed in which the correction as in the above-described embodiment is not performed. In such a comparative example, when the vehicle is moving, the vehicle shakes up, down, left, and right depending on the state of the road surface and the operation of the driver. From the viewpoint of the stereo camera, the road surface is constantly shaking, and accuracy of detecting a height at a predetermined position on the road surface deteriorates. Due to momentary shaking of the vehicle, non-existent unevenness or the like may be detected as if it were present.

The ECU 14 of the embodiment estimates the plane R obtained by calculation from the three-dimensional model, takes the normal vector Vc and the height position Hc as correct values, and corrects the three-dimensional model M so that the orientation of the normal vector Vr of the estimated plane R and the height position of the plane R match the normal vector Vc and the height position Hc. As a result, it is possible to suppress the influence of the shaking of the vehicle 1 and improve the detection accuracy of the height of the road surface.

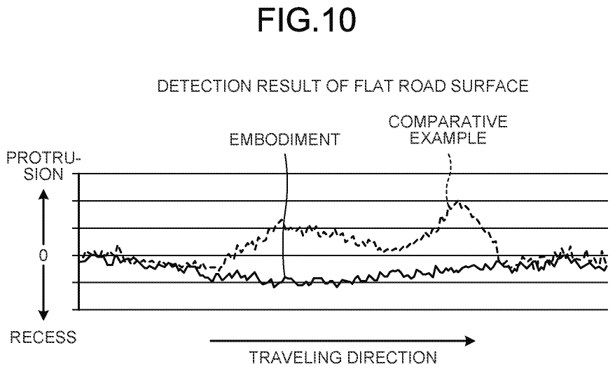

FIG. 10 is a graph of a detection result of a flat road surface by the ECU 14 according to the embodiment and a configuration according to the comparative example. The horizontal axis of the graph in FIG. 10 indicates a traveling direction of the vehicle, and the vertical axis indicates unevenness of the road surface. The road surface is set to be a zero point, and an upward direction is a protrusion (plus) side and a downward direction is a recess (minus) side across the zero point.

As illustrated in FIG. 10, in the configuration of the comparative example in which the three-dimensional model is not corrected, two large protrusions are detected even though the vehicle is traveling on a flat road surface. On the other hand, in the ECU 14 of the embodiment, a state of a substantially flat road surface is detected.

In this way, the ECU 14 of the embodiment can accurately detect the height of the unevenness of the road surface. Therefore, the ECU 14 of the embodiment can be applied to, for example, a parking support system, a suspension control system, and the like of the vehicle 1.

For example, in the parking support system of the vehicle 1, by accurately grasping the height of the unevenness of the road surface, it is possible to accurately predict the moving direction of the vehicle 1 when the vehicle 1 passes along a predetermined route. As a result, the vehicle 1 can be more reliably guided to a target parking space.

Further, in the suspension control system of the vehicle 1, by accurately grasping the height of the unevenness of the road surface, it is possible to accurately predict the shaking of the vehicle 1 when the vehicle 1 passes along a predetermined route. As a result, the shaking of the vehicle 1 can be suppressed more reliably.

### Other Embodiments

The road surface detection program executed by the ECU 14 of the above-described embodiment may be provided or distributed via a network such as the Internet. That is, the road surface detection program may be provided in a form of accepting downloads via the network while being stored on a computer connected to a network such as the Internet.

Although the embodiments of the present disclosure have been illustrated above, the above-described embodiments and modifications are merely examples, and the scope of the disclosure is not intended to be limited. The above-described embodiments and modifications can be implemented in various other forms, and various omissions, replacements, combinations, and changes can be made without departing from the gist of the disclosure. Further, the configuration and shape of each embodiment and each modification can be partially replaced.

### EXPLANATIONS OF LETTERS OR NUMERALS

1 VEHICLE

8 DISPLAY DEVICE

14 ECU

15 IMAGING UNIT

401 IMAGE ACQUISITION UNIT

402 THREE-DIMENSIONAL MODEL GENERATION UNIT

403 CORRECTION UNIT

404 STORAGE UNIT

Hc HEIGHT POSITION

M THREE-DIMENSIONAL MODEL

R PLANE

Vc, Vr NORMAL VECTOR

1. A road surface detection device comprising:
an image acquisition unit that acquires captured image data output from a stereo camera that captures an imaging area including a road surface on which a vehicle travels;
a three-dimensional model generation unit that generates a three-dimensional model of the imaging area including a surface shape of the road surface from a viewpoint of the stereo camera based on the captured image data; and
a correction unit that estimates a plane from the three-dimensional model, and corrects the three-dimensional model so as to match an orientation of a normal vector of the plane and a height position of the plane with respect to the stereo camera with a correct value of an orientation of a normal vector of the road surface and a correct value of a height position of the road surface with respect to the stereo camera, respectively.

2. The road surface detection device according to claim 1, wherein
the correction unit matches the orientation of the normal vector of the plane with the correct value of the orientation of the normal vector of the road surface, and then corrects an entirety of the three-dimensional model so as to match the height position of the plane with respect to the stereo camera with the correct value of the height position of the road surface with respect to the stereo camera.

3. The road surface detection device according to claim 2, wherein
the correction unit acquires the correct value of the orientation of the normal vector of the road surface and the correct value of the height position of the road surface with respect to the stereo camera based on values determined during calibration of the stereo camera.

4. A road surface detection computer program product having a non-transitory computer readable medium including programmed instructions, wherein the instructions, when executed by a computer, cause the computer to perform:
acquiring captured image data output from a stereo camera that captures an imaging area including a road surface on which a vehicle travels;
generating a three-dimensional model of the imaging area including a surface shape of the road surface from a viewpoint of the stereo camera based on the captured image data; and
estimating a plane from the three-dimensional model, and correcting the three-dimensional model so as to match an orientation of a normal vector of the plane and a height position of the plane with respect to the stereo camera with a correct value of an orientation of a normal vector of the road surface and a correct value of a height position of the road surface with respect to the stereo camera, respectively.
